(19) United States
(12) Patent Application Publication
(10) Pub. No.: US 2014/0268709 A1
(43) Pub. Date: Sep. 18, 2014

(54) CANDLE APPARATUS WITH LIGHT TRANSMISSIVE FIGURES

(71) Applicant: CHIN-SHENG YANG, Tainan City (TW)

(72) Inventor: CHIN-SHENG YANG, Tainan City (TW)

(21) Appl. No.: 13/802,824

(22) Filed: Mar. 14, 2013

(51) Int. Cl. F21V 15/01; F21L 4/00

(52) U.S. Cl. CPC F21V 15/01; F21L 4/00
USPC 362/190

(57) ABSTRACT

The present invention provides a candle apparatus with light transmissive figures comprising a base having a power supply unit provided thereon to receive a battery therein and electrically connected thereto to generate a power; a lighting unit provided on a top portion of the base and electrically connected to the power supply unit of the base; a light transmissive housing comprising a decorative figure layer on a housing wall thereof; and a light shield provided to cover a top portion of the housing. Therefore, as the light generated by the lighting unit passes through the housing and shone onto the decorative figure layer, the figures on the decorative figure layer are illuminated to show on the housing such that the candle apparatus of the present invention advantageously offers an illumination with unique visual effects as well as decorative and entertaining lighting.

### TECHNICAL FIELD OF THE INVENTION

The present invention is related to a candle apparatus, in particular, to an electronic candle.

### DESCRIPTION OF THE PRIOR ART

As modern lights and lighting fixtures continues to evolve and develop, the traditional lighting of candles nowadays is being used for decoration purposes in such as special occasions or events while the appearances of candles have always been of column shapes without significant variations. Furthermore, for traditional candles, the candle flame is known to be affected by its surrounding air and wind once lit, which is a concern to users as such flickering of candle flames in windy environment may either be blown off or may cause tipping off of the candle causing the hot candle wax to spill, leading to the occurrence of fire hazards or other dangerous accidents. There is a need for an improved candle apparatus capable of overcoming the drawbacks of the traditional candles.

### SUMMARY OF THE INVENTION

Accordingly, the present invention provides a candle apparatus with light transmissive figures comprising:

a base having a power supply unit provided on a lateral side thereof to receive a battery therein and electrically connected thereto to generate a power;

a lighting unit provided on a top portion of the base and electrically connected to the power supply unit of the base; and

a light transmissive housing comprising an opening and a decorative figure layer on a housing wall thereof; and wherein the housing covers an outer circumference of the base. Therefore, as the light generated by the lighting unit is shone onto and toward the decorative figure layer and passes through the housing to the exterior thereof, the candle apparatus of the present invention is able to produce a unique atmospheric lighting for decorative purposes and such that a rich and entertaining illumination effects with active and decorative lighting can be advantageously achieved.

### BRIEF DESCRIPTION OF THE DRAWINGS

FIG. 1 is a perspective view of the present invention;

FIG. 2 is an exploded view of the present invention;

FIG. 3 is a lateral cross sectional view of the present invention; and

FIG. 4 is a bottom perspective view of the present invention.

### DETAILED DESCRIPTION OF THE PREFERRED EMBODIMENTS

Please refer to FIG. 1 to FIG. 3, showing a preferred embodiment of a candle apparatus with light transmissive figures of the present invention. As shown in the figure, the candle apparatus with light transmissive figures of the present invention comprises:

a base 1 having a power supply unit 11 provided on a lateral side thereof to receive a battery therein and electrically connected thereto to generate a power; wherein the base 1 further comprises a securement slot 12 on a top portion thereof and a bottom cap 13 attached to a bottom portion of the base 1;

a lighting unit 2 comprising a circuit board 21 inserted into the securement slot 12 and electrically connected to the power supply unit 11 of the base 1; wherein the circuit board 21 comprises at least one lighting element 22 electrically connected thereto; and

a light transmissive housing 3 comprising an opening 31 covering an outer circumference of the base 1; wherein the housing 3 comprises a decorative figure layer 32 on a housing wall thereof.

As shown in FIG. 4, in an embodiment of the present invention, the base 1 further comprises a switch 14 having one end electrically connected to the power supply unit 11 and another end electrically connected to the circuit board 21. The switch 14 is used for controlling on and off states of the lighting elements 22 of the lighting unit 2 of the lighting unit 2. The top portion of the housing 3 comprises a through-hole 34, and two lighting elements 22 spaced apart from each other are electrically connected to the circuit board 21; wherein one of the lighting elements 22 is provided on a top of the circuit board 21 and is partially exposed from the through-hole 34. The through-hole 34 is configured to receive a light shield 4 arranged thereon; wherein the light shield 4 is of a hollow shape of a candle flame. In this embodiment, the two lighting elements 22 are color LED lights, and the circuit board 21 can be used to control a color changing sequence of the LED lights. In addition, the decorative figure layer 32 is a light transmissive slat attached to an inner side of the housing wall of the housing 3. Therefore, the two lighting elements 22 are able to shine lights onto and toward the decorative figure layer 32 to passing through the housing 3 and the exterior thereof such that a unique atmospheric lighting for decorative purposes can be advantageously achieved.

The decorative figure layer 32 can be provided on the inner side of the housing wall of the housing 3 via a formation method of a vacuum platting by coating an inner layer thereon and followed by laser engraving to form desired figures on the layer in order to obtain the decorative figure layer 32 of the present invention. In view of the above, the candle apparatus with light transmissive figures of the present invention can be advantageously used as a replacement for traditional candles while offering various ways and design possibilities of manipulating and creating desired figures of the decorative figure layer 32 provided thereon such that the candle apparatus with light transmissive figures of the present invention is of the merits of improved illumination effects having a rich and entertaining visual presentation and with active and decorative lighting.

What is claimed is:

1. A candle apparatus with light transmissive figures, comprising:
a base having a power supply unit provided on a lateral side thereof to receive a battery therein and electrically connected thereto to generate a power;
a lighting unit provided on a top portion of said base and electrically connected to said power supply unit of said base; and
a light transmissive housing comprising an opening and a decorative figure layer on a housing wall thereof; and wherein said housing covers an outer circumference of said base.

2. The candle apparatus with light transmissive figures according to claim 1, wherein said lighting unit comprises a circuit board electrically connected to at least one lighting element; and said circuit board is electrically connected to said power supply unit.

3. The candle apparatus with light transmissive figures according to claim 1, wherein said top portion of said housing comprises a through-hole for receiving a light shield arranged thereon.

4. The candle apparatus with light transmissive figures according to claim 1, wherein said base comprises a switch having one end electrically connected to said power supply unit and another end electrically connected to said lighting unit to control on and off states of said lighting unit.

5. The candle apparatus with light transmissive figures according to claim 1, wherein said decorative figure layer is a light transmissive slat attached onto an inner side of said housing wall of said housing.
